(19) United States
(12) Patent Application Publication
(10) Pub. No.: US 2026/0257828 A1
(43) Pub. Date: Sep. 3, 2026

(54) LABEL APPLICATION DEVICE

(71) Applicant: New Path Label Applicators, LLC, Morris, NY (US)

(72) Inventors: Paul F. Koch, Morris, NY (US); Julianne P. Koch, Morris, NY (US)

(21) Appl. No.: 19/554,486

(22) Filed: Mar. 2, 2026

Related U.S. Application Data
(60) Provisional application No. 63/790,354, filed on Apr. 17, 2025.
(60) Provisional application No. 63/765,977, filed on Mar. 3, 2025.

(51) Int. Cl. B65C 9/00; B65C 9/08; B65C 9/36

(52) U.S. Cl. CPC B65C 9/0006; B65C 9/0015; B65C 9/08; B65C 9/36; B65C 2009/0009

(57) ABSTRACT

A label application device includes a channel mounting plate. The label application device includes a first slide channel and a second slide channel connected to the channel mounting plate substantially parallel to each other. The channel mounting plate is configured to secure the first slide channel and the second slide channel at an angle of about negative 10 degrees to about 30 degrees relative to a horizontal plane to receive an adhesive label directly from a printer and to facilitate separation of backing paper from the adhesive label via a peel bar. The first slide channel and the second slide channel each have a corresponding textured surface to provide a discontinuous contact surface for receiving the adhesive label with adhesive side down during and after the adhesive label is ejected from the printer.

### RELATED APPLICATIONS

This application claims the benefit of U.S. Provisional Patent Application No. 63/790,354 filed Apr. 17, 2025 and U.S. Provisional Patent Application No. 63/765,977 filed Mar. 3, 2025, the contents of which are incorporated by reference in their entirety herein.

### TECHNICAL FIELD

Embodiments of the present disclosure relate to devices, and in particular to label application devices.

### BACKGROUND

Labels are used for various purposes, including for household uses to large production uses. Labels can be made of various materials and in different shapes. Labels can be separately produced and applied on various objects.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIGS. 1A-D illustrate label application devices, according to certain embodiments.

FIGS. 2A-D illustrate slide channels of label application devices, according to certain embodiments.

FIGS. 3A-C illustrate slide channels of label application devices, according to certain embodiments.

FIGS. 4A-D illustrate slide channels of label application devices, according to certain embodiments.

FIGS. 5A-D illustrate slide channels of label application devices, according to certain embodiments.

FIGS. 6A-E illustrate a label application device applying an adhesive label to a product, according to certain embodiments.

FIGS. 7A-B illustrate a label application device applying an adhesive label to a product, according to certain embodiments.

FIGS. 8A-B illustrate a label application device applying an adhesive label to a product, according to certain embodiments.

FIG. 9 illustrates a perspective view of a label application device, according to certain embodiments.

### DETAILED DESCRIPTION OF EMBODIMENTS

Embodiments described herein are related to label application devices. The present disclosure is also associated with treating metal surfaces to reduce pressure sensitive adhesive bonding (e.g., associated with label application devices). The present disclosure is also associated with label application systems which may include a mechanical device that assists in the application of adhesive labels printed by desktop label printers, improving the speed consistency, and accuracy of the label application process. The present disclosure is also associated with label application systems which may include a mechanical device that assists in the application of adhesive labels printed by weigh scales, improving the speed, consistency, and accuracy of the label application process

Labels with pressure sensitive adhesive can be applied by hand or by machine. Application of labels by hand is slow and error prone. Machine application is often preferred when applying multiple labels because a machine can apply labels faster and with more accuracy than hand application. For machine applied labels, various methods have been developed to transfer the labels from a label roll to the final product surface where the label is to be applied. Conventionally, label applicator machines try to avoid contact with the adhesive side of the label. Conventional label applicator machines that contact the adhesive side of the label have issues with the label adhesive sticking to machine parts.

The present disclosure avoids having labels stick to the machinery or having label adhesive material accumulate on machinery parts. In some embodiments, the label application device includes one or more components (e.g., that may come in contact with adhesive) that are coated or covered with a low surface energy material such as silicone (e.g., silicone oil), other similar lubricant, or a specialized non-stick plasma coating.

In some embodiments, the present disclosure forms a rough textured finish on metal part surfaces of the label application device. The textured finish may reduce adhesive sticking to the parts and it also reduces (e.g., largely prevents) the accumulation of adhesive on the textured part surfaces compared to conventional systems. In some embodiments, the present disclosure utilizes the textured surface on the channel shaped structures (slide channels) of the label application device that support the labels after the labels have been removed from the label liner paper and before the labels are applied to products. In some embodiments, the slide channels are configured to contact the adhesive face of labels and the treatment of the slide channel edge surface that contacts the labels is part of the present disclosure.

Desktop thermal label printers are used in packaging operations for printing self-adhesive labels. However, these printers typically lack integrated mechanisms to apply the printed labels to products. As a result, users must manually apply each label, which is slower, less accurate, and often results in additional handling of the label adhesive surface, increasing the potential for contamination or improper alignment.

Machine-applied labeling, common in industrial settings, offers superior speed and accuracy. The absence of a compact, low-cost, and effective solution for automating label application from desktop printers represents a significant gap in the market—one that the present disclosure addresses.

Weigh scales are used to measure the weight of items. They come in many forms. Some are designed to weigh very small items weighing a fraction of an ounce and some are used to measure the weight of extremely heavy items. Some weigh scales offer the ability to send the weight data to a printer. Printing weigh scales are scales that have a printer incorporated within the scale unit. Some printing weigh scales print on self-adhesive label material. Labels from these printers are typically presented to the operator with the label liner paper removed so the labels can be quickly applied to a weighed product without having to peel off the liner paper.

Conventional portable printing weigh scales do not offer the ability to have the labels machine-applied. As a result, the operator must manually apply each label. Compared to machine-applied labels, the manual label application process is slower, less accurate, and often results in additional handling of the label adhesive surface, increasing the potential for contamination or improper alignment.

Machine-applied labeling offers superior speed and accuracy. The absence of a compact, low-cost, and effective solution for automating label application for printing weigh scales represents a significant gap in the market.

The present disclosure provides solutions to shortcomings of conventional processes. In some embodiments, the present disclosure provides treating metal surfaces to reduce pressure sensitive adhesive bonding (e.g., associated with label application devices). In some embodiments, the present disclosure includes improvements to the process for creating a textured edge on the channels (e.g., associated with label application devices). In some embodiments, a method includes texturing a tapered edge of a slide channel plate in a planar shape. The slide channel plate is of a label application device. The method further includes, subsequent to the texturing, bending the slide channel plate into a channel shape. The slide channel plate in the channel shape is to support adhesive labels.

In some embodiments, the present disclosure provides a label application device (e.g., compact label application device) configured to work in conjunction with desktop label printers. In some embodiments, the label application device receives a printed label as the printed label exits the printer and holds the printed label in a position for precise application to flat packaging surfaces. In some embodiments, the label application device minimizes manual contact with the label and provides more consistent alignment and adhesion than conventional processes. In some embodiments, the present disclosure uses either slide channels or an air suction chamber to hold the label in place during transfer (e.g., from the printer to the product).

During operation, a label may be printed from a printer (e.g., desktop printer, industrial type printer). As the label exits the printer, the adhesive side faces downward and the leading edge of the label passes over the printer's peel bar, separating the adhesive label from the liner (or simulating this function in liner-less systems).

The label then enters the label application device (e.g., label holding assembly), which aligns and supports the label using two parallel slide channels. The slide channels may be slightly shorter than the label itself, allowing the leading edge of the label to extend slightly beyond the end of the slide channels. The label application device may include a press bar positioned above (e.g., directly above) the leading edge of the adhesive label.

To apply the label, a product may be brought upward (e.g., the user brings a package upward) to contact the exposed leading edge. As pressure is applied, the label adheres to the product (e.g., package). Continued upward and rearward movement of the package causes the remainder of the label to adhere evenly. Once the label is fully transferred, the process is complete and ready for repetition.

In some embodiments, the present disclosure provides a compact label application device configured to work in conjunction with a printer (e.g., portable printing weigh scales) that present a label with the liner paper removed as the label exits the printer. The printer may be a scale that dispenses labels in a horizontal or vertical orientation. The present disclosure may include a label application device that mechanically receives a printed label as the printed label exits the printer (e.g., scale printer) and may hold the printed label in a position for application (e.g., precise application, application in a particular location, application within a threshold distance of a particular location) to a surface of a product (e.g., packaging surface). The label application device may minimize manual contact with the label and may provide (e.g., ensures) more consistent alignment and adhesion.

The systems, devices, and methods disclosed herein have advantages over conventional solutions. The present disclosure may have less (e.g., no) accumulated adhesive (e.g., in the label application device) and less labels sticking to components compared to conventional systems. The present disclosure may have less errors than conventional systems. The present disclosure is quicker and has less errors than manually placing labels. The present disclosure may be applied to a wider range of printers (e.g., desktop printers, industrial type printer, scale printers, etc.) than conventional systems.

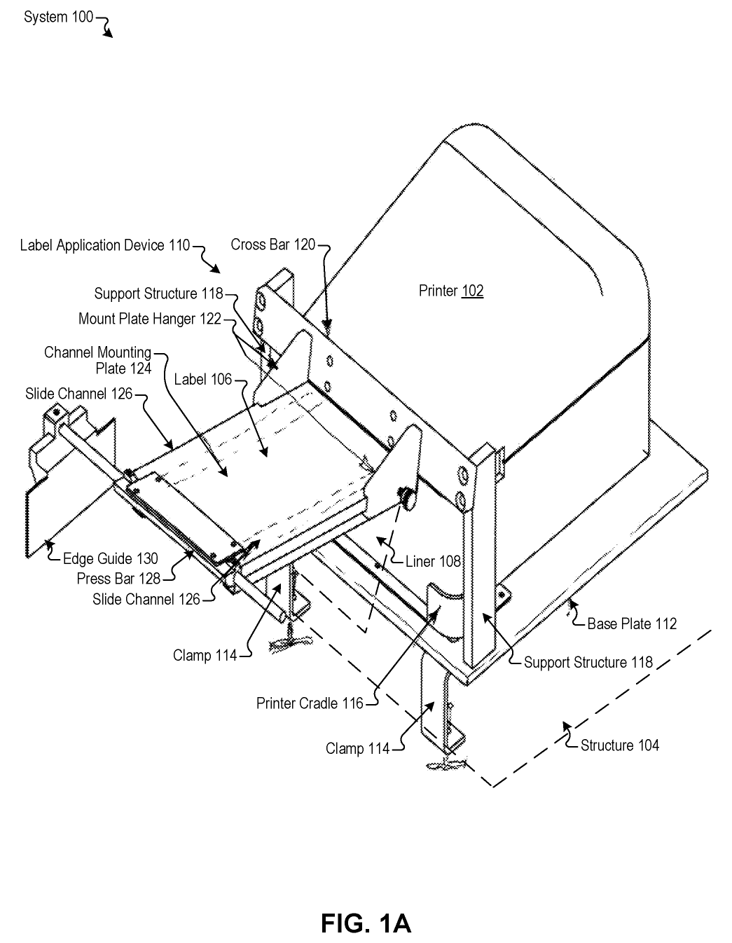

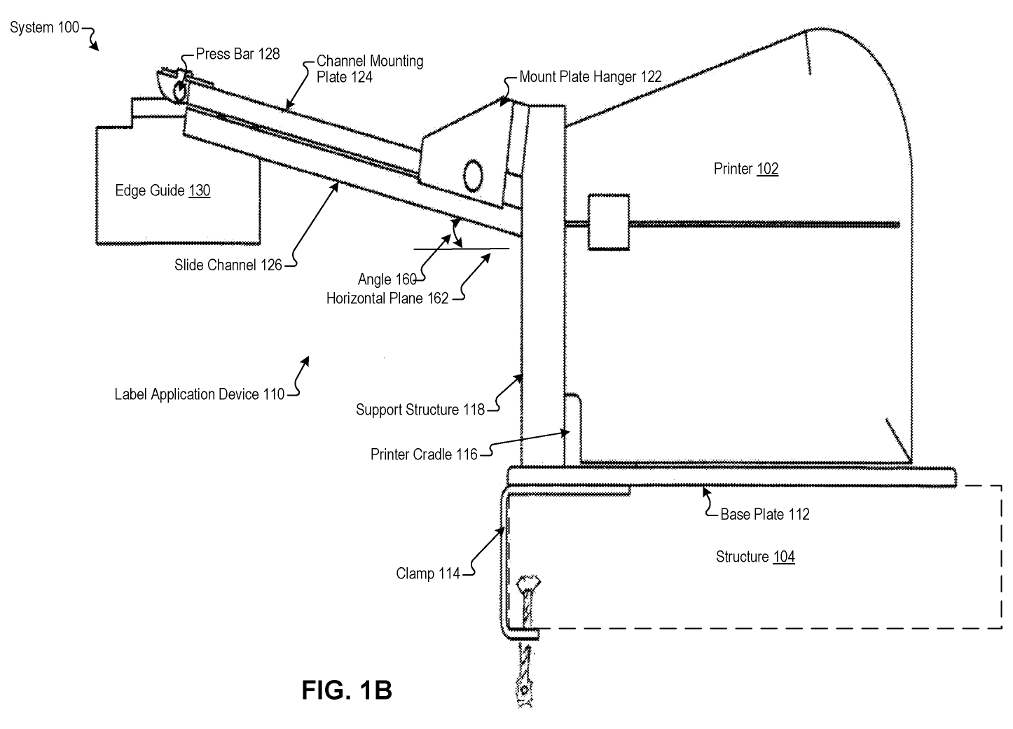

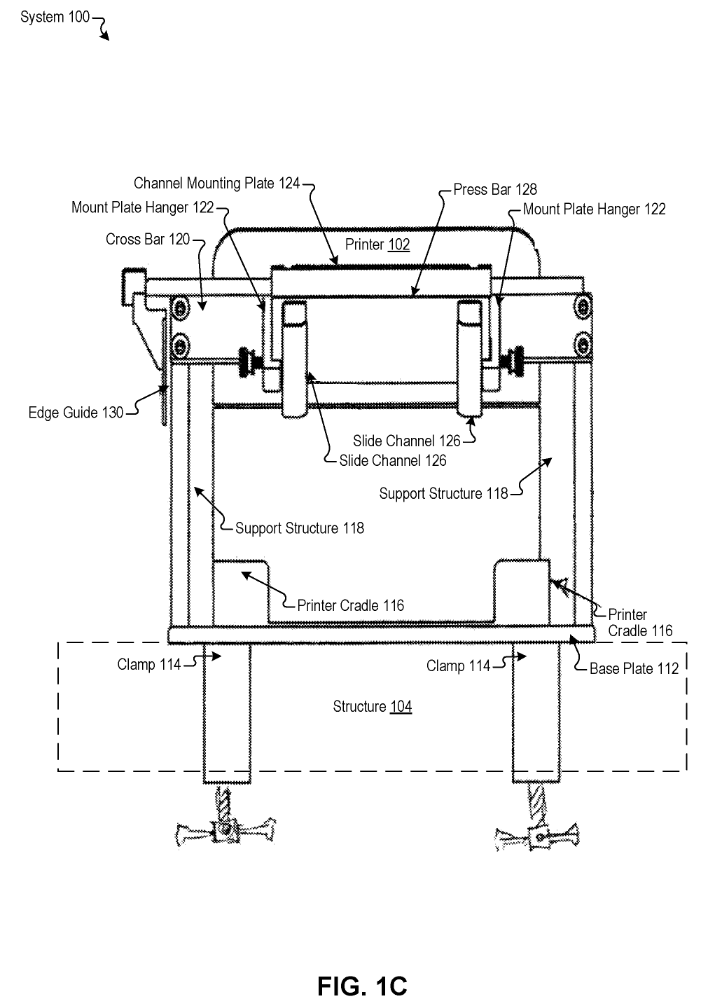

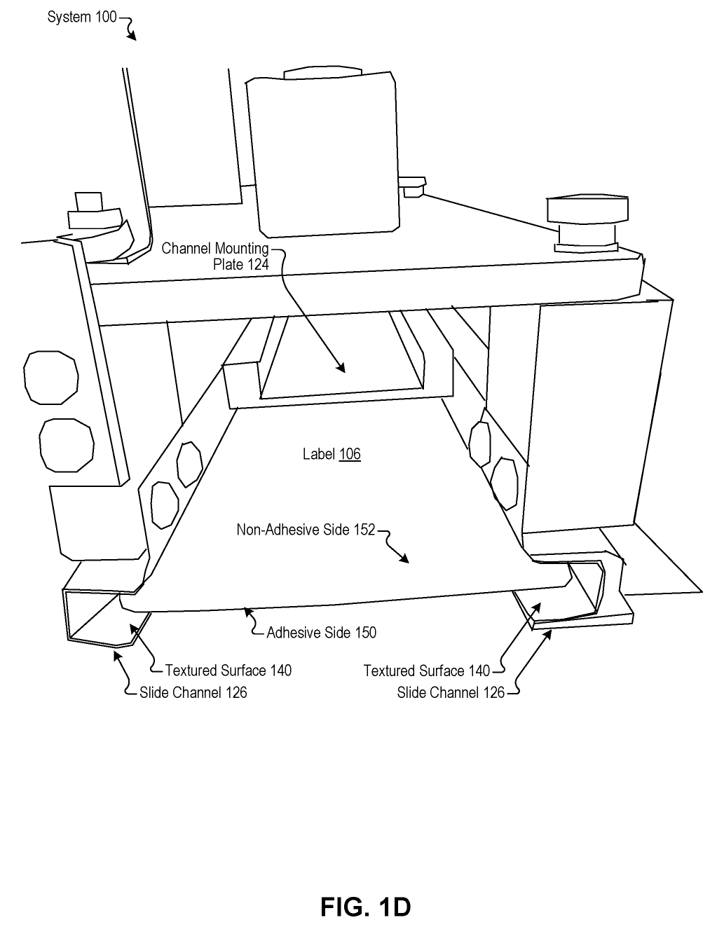

FIGS. 1A-D illustrate label application devices 110, according to certain embodiments. FIG. 1A is a perspective view, FIG. 1B is a side view, FIG. 1C is a front review, and FIG. 1D is a perspective view. One or more of FIGS. 1A-D may be of the same label application device 110.

A system 100 may include a printer 102, a structure 104, and/or a label application device 110.

The printer 102 may be one or more of a desktop printer, industrial type printer, a printing weigh scale, a portable printer, a portable printing weigh scale, or a portable desktop printer. The printer 102 may be configured to print the adhesive label 106 via one or more of thermal printing or ink jet laser printing. The printer 102 may be configured to print an adhesive label 106. In some embodiments, the printer 102 prints the adhesive label 106 in a substantially horizontal orientation. In some embodiments, the printer 102 prints the adhesive label 106 in a substantially vertical orientation. In some embodiments, the printer 102 prints the adhesive label 106 and removes the liner 108 from the adhesive label 106. In some embodiments, the adhesive label 106 is a liner-less adhesive label.

The structure 104 may be a table, a countertop, a stand, a bench, a benchtop, etc. The label application device 110 may be placed on the structure 104. The label application device 110 may be removably secured to the structure 104.

In some embodiments, adhesive label 106 is peeled from a liner (e.g., backing paper). The adhesive label 106 may be peeled from a liner via a peel bar (e.g., of printer 102). In some embodiments, adhesive label 106 is liner-less.

The label application device 110 may include a base plate 112 configured to be placed on the structure 104.

The label application device 110 may include one or more clamps 114 (e.g., clamp to benchtop) connected to the base plate 112. In some embodiments, the one or more clamps 114 are configured to releasably connect the label application device 110 to the structure 104.

The label application device 110 may include a printer cradle 116 configured to at least partially secure a printer 102. In some embodiments, a printer cradle 116 is connected to the base plate 112. The printer cradle 116 is configured to at least partially restrain movement of the printer 102. The printer cradle 116 is configured to position the printer 102 to eject the adhesive label 106 into the first slide channel 126A and the second slide channel 126B.

The label application device 110 may include one or more support structures 118 (e.g., frame upright structures) that each have a corresponding first distal end secured to the base plate 112. In some embodiments, the one or more support structures 118 each have a corresponding first distal end connected to the base plate 112. The one or more support structures 118 position the first slide channel 126A and the second slide channel 126B at a height to directly receive the adhesive label 106 ejected from the printer 102 to cause a first side of the adhesive label 106 to be disposed in the first slide channel 126A and a second side of the adhesive label 106 to be in the second slide channel 126B with an adhesive side 150 of the adhesive label 106 facing down and liner 108 (e.g., liner paper) peeled from the adhesive label 106.

The label application device 110 may include a cross bar 120 connected to the one or more support structures 118 (e.g., frame upright structures). In some embodiments, the cross bar 120 is connected to a corresponding second distal end of each of the one or more support structures 118.

The label application device 110 may include one or more mount plate hangers 122 connected to the cross bar 120. In some embodiments, the one or more mount plate hangers 122 are connected to the cross bar 120 and the channel mounting plate 124 is coupled to the one or more mount plate hangers 122.

The label application device 110 may include a channel mounting plate 124 that may be coupled (e.g., secured, connected, fastened) to the one or more mount plate hangers 122. In some embodiments, the channel mounting plate 124 is substantially transparent.

The label application device 110 may include slide channels 126 that may include a first slide channel 126A and a second slide channel 126B that are substantially parallel to each other.

In some embodiments, the first slide channel 126A and the second slide channel 126B are connected to the channel mounting plate 124 substantially parallel to each other. The channel mounting plate 124 is configured to secure the first slide channel 126A and the second slide channel 126B at an angle of about negative 10 degrees to about 30 degrees relative to a horizontal plane to receive an adhesive label 106 directly from a printer 102 and to facilitate separation of liner 108 (e.g., backing paper) from the adhesive label 106 via a peel bar (e.g., of printer 102).

The first slide channel 126A and the second slide channel 126B each have a corresponding textured surface 140 to provide a discontinuous contact surface for receiving the adhesive label 106 with adhesive side 150 down during and after the adhesive label 106 is ejected from the printer 102. In some embodiments, each corresponding textured surface 140 are beveled and a textured with one or more of an embossed or cut (e.g., machine cut) sawtooth pattern, abrasive surface treatment, or bonded granular coating. In some embodiments, wherein a lubricant comprising silicone oil or similar lubricant is applied to each corresponding textured surface 140.

In some embodiments, the first slide channel 126A and the second slide channel 126B maintain the adhesive label 106 in a substantially planar position responsive to the adhesive label 106 being ejected from the printer 102.

In some embodiments, the adhesive label 106 is secured by the first slide channel 126A and the second slide channel 126B to cause an adhesive face of a leading edge of the adhesive label 106 to be fully exposed for application to a product.

The label application device 110 may include a press bar 128. A product that is to be labeled is to be pressed against a leading adhesive face of the adhesive label 106 to cause the adhesive label 106 to be pressed against the press bar 128 to cause the adhesive label 106 to be adhered to the product.

In some embodiments, the press bar 128 is coupled to the channel mounting plate 124. In some embodiments, the press bar 128 is a cylindrically-shaped structure positioned in alignment with a leading edge of the adhesive label 106 and positioned opposite to the adhesive side 150 of the adhesive label 106. A product that is to be labeled is to be pressed against a leading adhesive face of the adhesive label 106 to cause the adhesive label 106 to be pressed against the press bar 128 to cause the adhesive label 106 to be adhered to the product.

The label application device 110 may include an edge guide 130 secured to the press bar 128 to align the product with the adhesive label 106. In some embodiments, the edge guide 130 is an adjustable edge guide coupled to the press bar 128. The adjustable edge guide 130 is configured to align a product with the adhesive label 106.

FIG. 1B illustrates a side view of system 100 including label application device 110 and printer 102. The slide channels 126 may be disposed at an angle 160 relative to the horizontal plane 162.

In some embodiments, the channel mounting plate 124 is configured to secure the first slide channel 126A and the second slide channel 126B at an angle 160. In some embodiments, the angle 160 is about negative 10 degrees to about 30 degrees relative to a horizontal plane 162. In some embodiments, the angle 160 is about 5 degrees to about 30 degrees relative to a horizontal plane 162. In some embodiments, the angle 160 is about negative 10 degrees to about positive 10 degrees relative to a horizontal plane 162. In some embodiments, the angle is substantially horizontal (e.g., substantially in horizontal plane 162). In some embodiments, the angle 160 is substantially vertical (e.g., substantially orthogonal to horizontal plane 162). In some embodiments, the angle 160 is about 10 degrees to about 20 degrees relative to a horizontal plane 162.

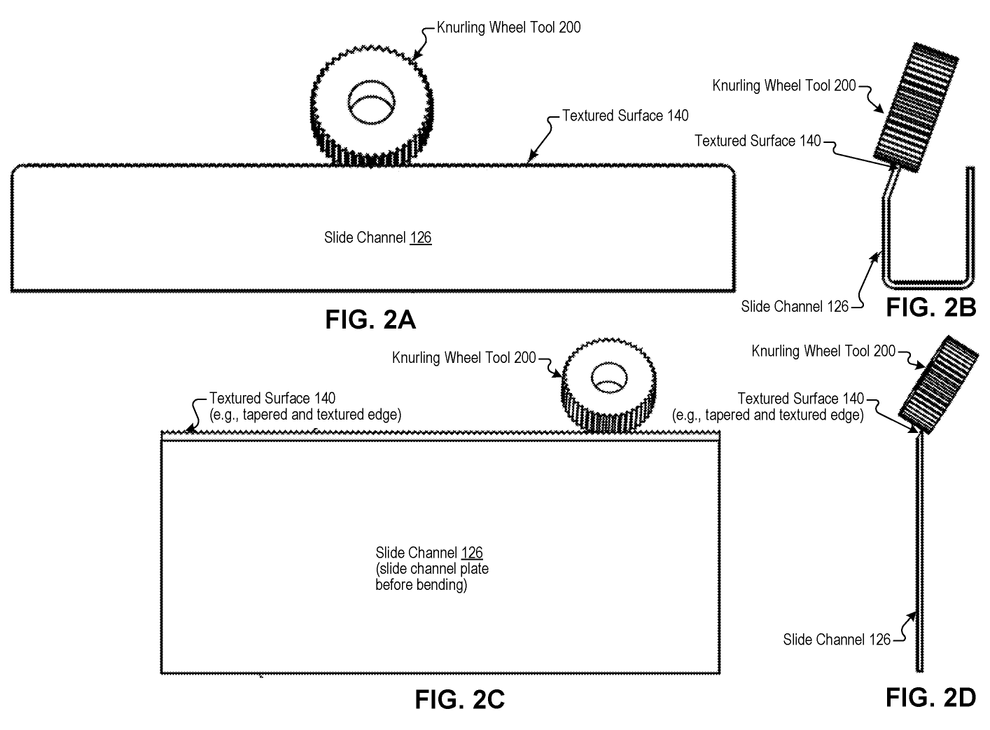

FIG. 1D illustrates a pair of slide channels 126 which are supporting an adhesive label 106. The adhesive side 150 of the label is contacting the textured surfaces 140 (e.g., edges) of the slide channels 126 that have been textured (e.g., received the textured treatment from the knurling wheel 200 of one or more of FIGS. 2A-D). The surface texturing (e.g., edge texturing) process may prevent adhesive labels 106 from sticking to the slide channel 126 surfaces (e.g., channel edge surfaces).

FIGS. 2A-D illustrate slide channels 126 of label application devices 110, according to certain embodiments.

In some embodiments, textured surfaces 140 (e.g., slide channel edges) of label application devices 110 may be textured by rolling a knurling tool wheel 200 on the edge or surface of the formed slide channel 126 after the channel plate has been bent into the final slide channel shape (e.g., see FIGS. 2A-B). FIGS. 2A-B illustrates a slide channel 126 with a knurling tool wheel 200 that is used to create a textured surface 140 on the channel edge. FIGS. 2C-D illustrate forming the textured surface 140 (e.g., tapered and textured edge) of the slide channel 126 prior to bending the slide channel 126.

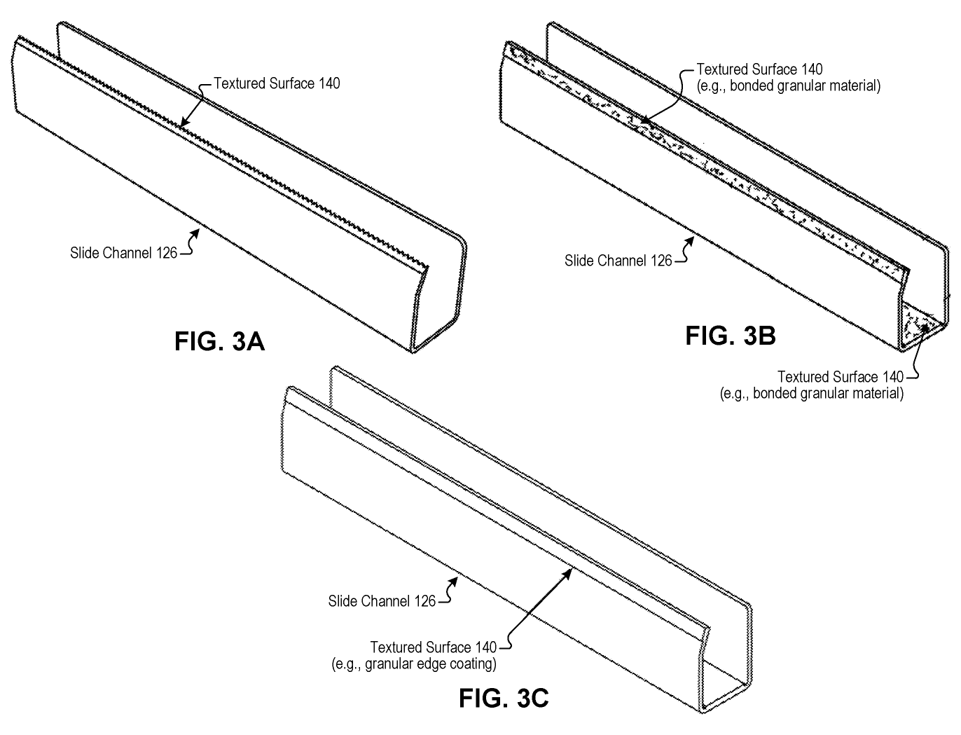

FIGS. 3A-C illustrate slide channels 126 of label application devices 110, according to certain embodiments. Slide channels 126 may have textured surfaces 140 (e.g., textured edges) where the adhesive side 150 of an adhesive label 106 is to be disposed. The textured surface 140 may be tapered (e.g., thinner towards the edge).

Referring to FIG. 3A, the textured surface 140 may include a knurled surface. Referring to FIG. 3B, the textured surface 140 may include a bonded granular material. The textured surface may include the edge of the slide channel 126 and the inner side wall of the slide channel 126. Referring to FIG. 3C, the textured surface 140 may include a granular edge coating.

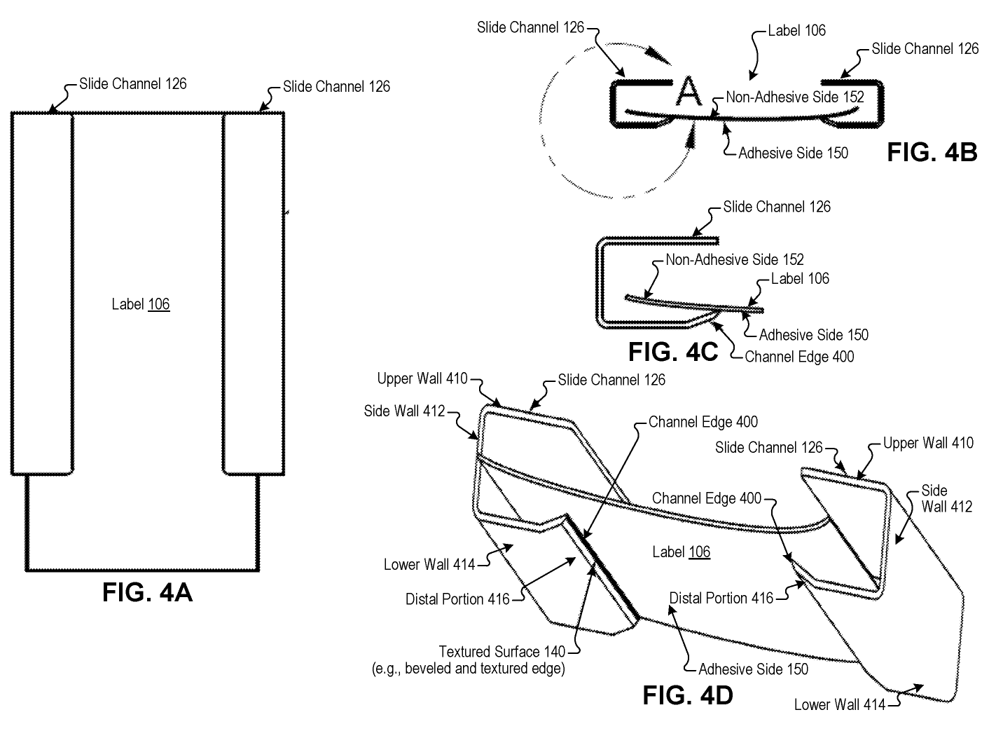

FIGS. 4A-D illustrate slide channels 126 of label application devices 110, according to certain embodiments. The slide channels 126 may secure a label 106.

FIG. 4A may be an upper view. Slide channels 126 may be configured to support a label 106. The slide channels 126 may be shorter than the label 106 so that a distal portion of the label 106 extends from the slide channels 126 so that the distal portion of an adhesive label 106 can be applied to a product (e.g., package, envelope).

FIG. 4B may be a front view and FIG. 4C may be an enlarged view of section A of FIG. 4B. FIG. 4D may be a lower perspective view. The side channels 126 may be bent to have an upper wall 410, a side wall 412, and a lower wall 414. The lower wall 414 may be further bent so that the distal portion 416 of the lower wall 414 is angled upwards so that the channel edge 400 of the lower wall 414 (e.g., of of the distal portion 416 of lower wall 414) contacts the adhesive side 150 of the label 106 (e.g., the adhesive side 150 is facing down and the non-adhesive side 152 is facing up). The channel edge 400 may be a textured surface 140 (e.g., discontinuous surface) to avoid the label 106 from adhering to the slide channel 126 and to avoid adhesive build up on the slide channel 126.

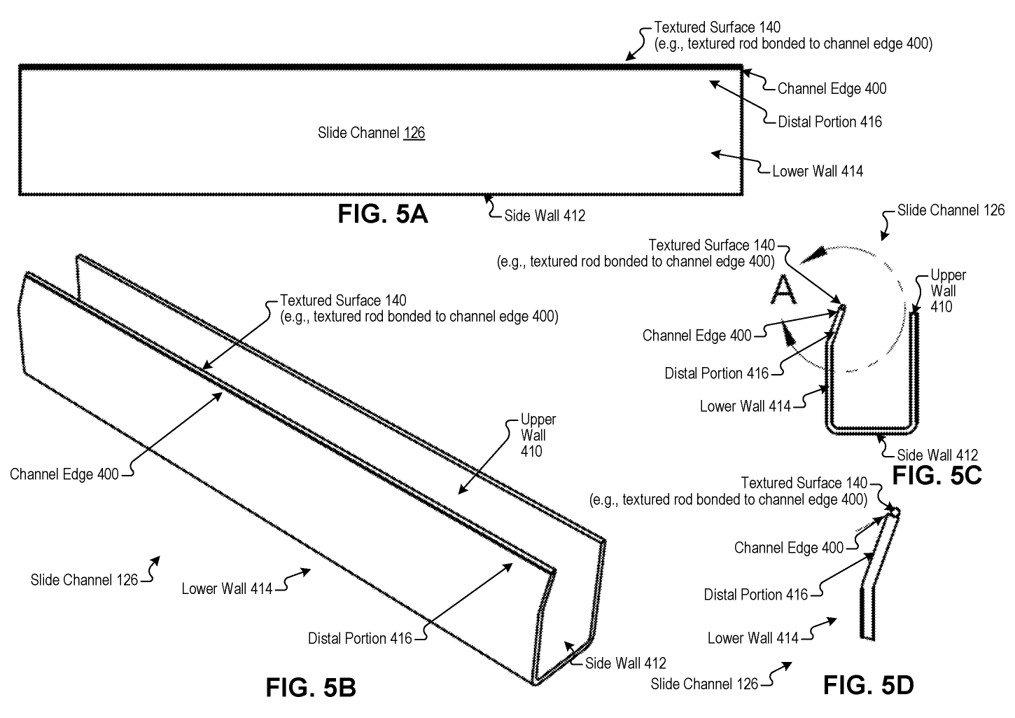

FIGS. 5A-D illustrate slide channels 126 of label application devices 110, according to certain embodiments. FIG. 5A illustrates a side view, FIG. 5B illustrates a perspective view, FIG. 5C illustrates a front view, and FIG. 5D illustrates an enlarged view of section A of FIG. 5C.

In some embodiments, the slide channel 126 includes an upper wall 410, side wall 412, and lower wall 414. The lower wall may include a distal portion 416 and a channel edge 400. The slide channel 126 may have a textured surface 140. In some embodiments, the textured surface is a textured rod bonded to channel edge 400. The textured rod may be the same or a different material than the slide channel 126.

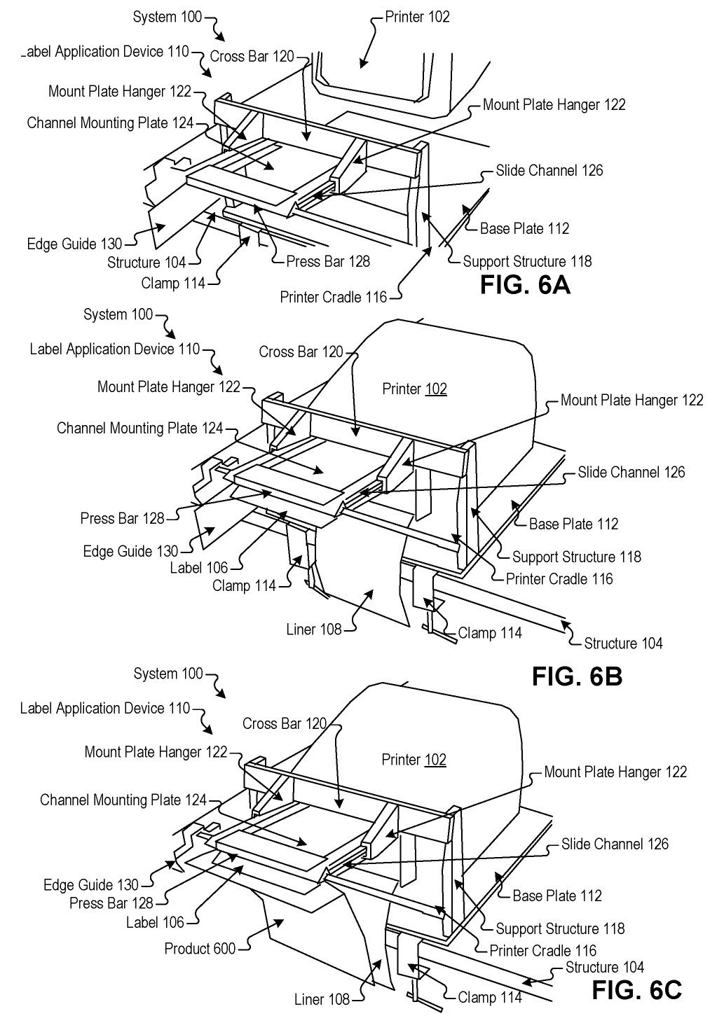

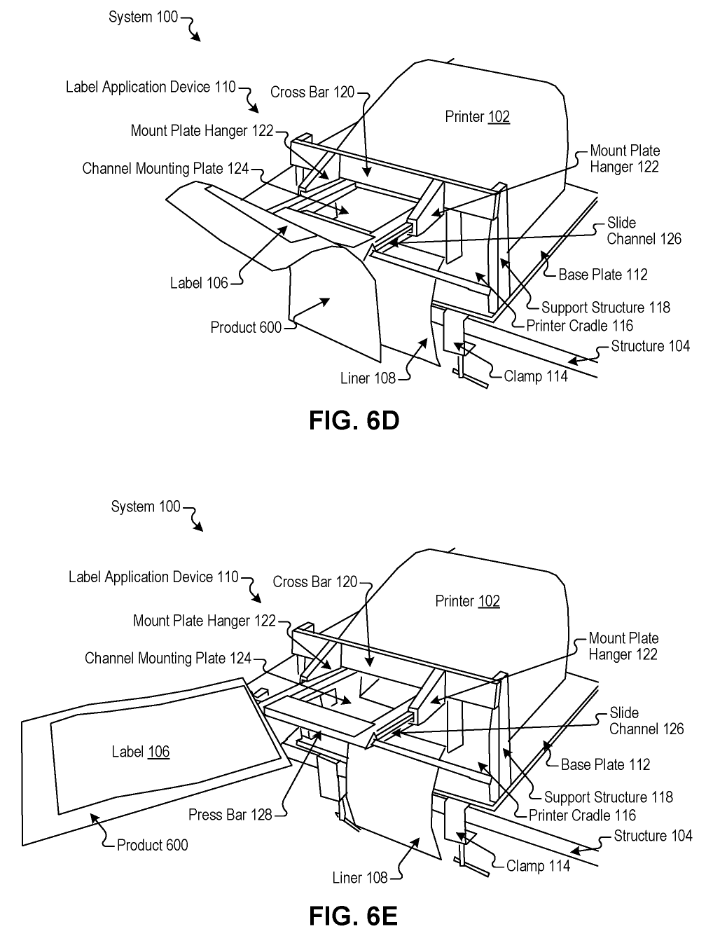

FIGS. 6A-E illustrate a label application device 110 applying an adhesive label 106 to a product 600, according to certain embodiments.

Referring to FIG. 6A, a label application device 110 is placed on structure 104 and mounted to structure 104 via clamps 114. A printer is placed on the base plate 112 and at least secured via printer cradle 116.

Referring to FIG. 6B, the printer 102 prints and ejects an adhesive label 106 directly into slide channels 126 and a distal portion of adhesive label 106 extends from the label application device 110 (e.g., from the slide channels 126). In some embodiments, as the adhesive label 106 is ejected from the printer 102, the liner 108 separates from the adhesive label 106. The liner 108 extends downward (e.g., substantially vertically) and the adhesive label 106 extends substantially horizontally (e.g., about negative 10 to about 30 degrees from the horizontal plane).

Referring to FIG. 6C, a product 600 (e.g., envelope) is brought in contact with the distal portion of the adhesive label 106 that is extending from the label application device 110. The product 600 is pressed upward against the distal portion of the adhesive label 106 which presses against the press bar 128 to adhere the distal portion of the adhesive label 106 to the product 600.

Referring to FIG. 6D, the product 600 is pulled upwards and pulls the adhesive label 106 partially out of the label application device 110 (e.g., slide channels 126) while pushing the adhesive label 106 and the product 600 against the press bar 128 to adhere more portions of the label 106 to the product 600.

Referring to FIG. 6E, the product 600 is pulled further away from the label application device 110 and pulls the adhesive label 106 out of the label application device 110 (e.g., slide channels 126) while pushing the rest of the adhesive label 106 and the product 600 against the press bar 128 to adhere the rest of the label 106 to the product 600.

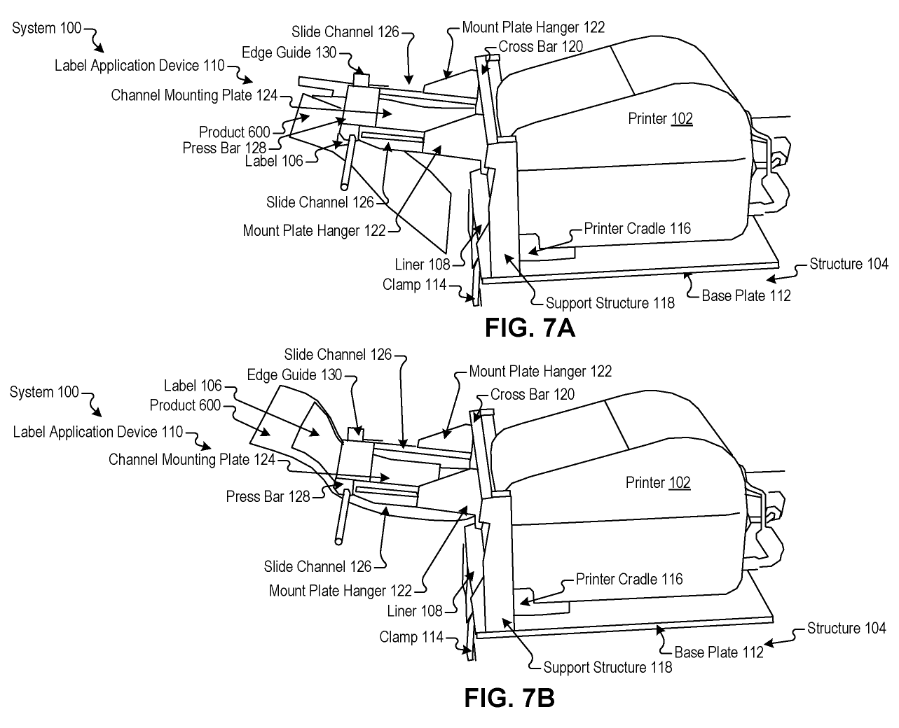

FIGS. 7A-B illustrate a label application device 110 applying an adhesive label 106 to a product 600, according to certain embodiments.

Referring to FIG. 7A, a product 600 is brought in contact with the distal portion of the adhesive label 106 and is pressed against the press bar 128 to adhere the distal portion of the adhesive label 106 to the product 600.

Referring to FIG. 7B, the product 600 is pulled away from the label application device 110 while pushing the product 600 and label 106 against the press bar 128 to adhere the adhesive label 106 to the product 600.

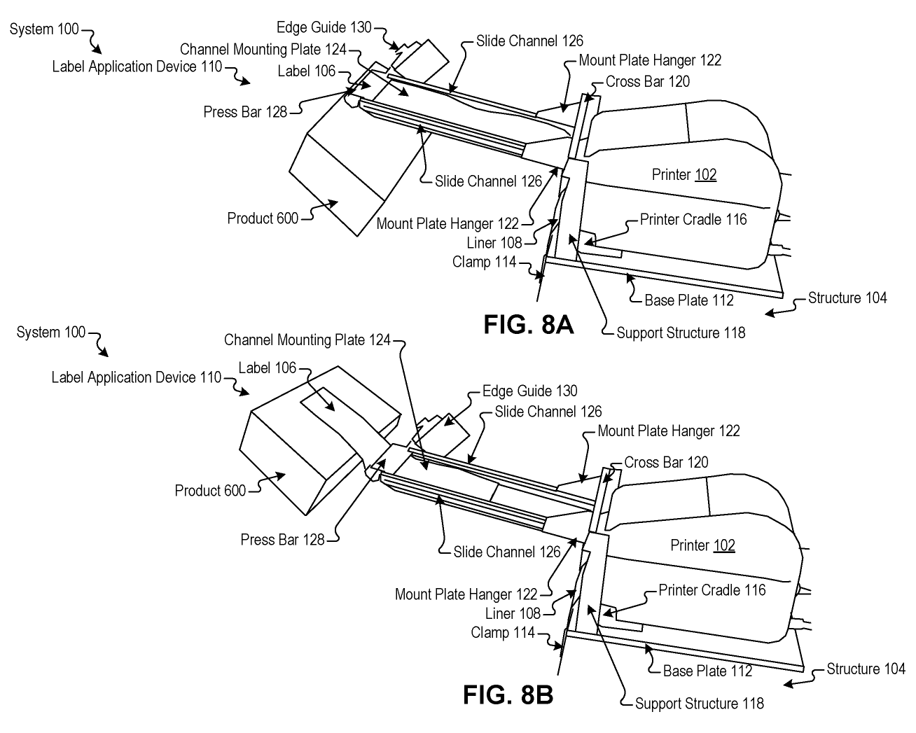

FIGS. 8A-B illustrate a label application device 110 applying an adhesive label 106 to a product 600, according to certain embodiments.

Referring to FIG. 8A, a product 600 is brought in contact with the distal portion of the adhesive label 106 and is pressed against the press bar 128 to adhere the distal portion of the adhesive label 106 to the product 600. The slide channels 126 may be longer than those in FIGS. 6A-E and FIGS. 7A-B to accommodate longer adhesive labels 106 to wrap around a product 600 (e.g., box).

Referring to FIG. 8B, the product 600 is pulled away from the label application device 110 while pushing the product 600 and label 106 against the press bar 128 to adhere the adhesive label 106 to the product 600. The product 600 may be rotated to wrap the adhesive label 106 around the product 600.

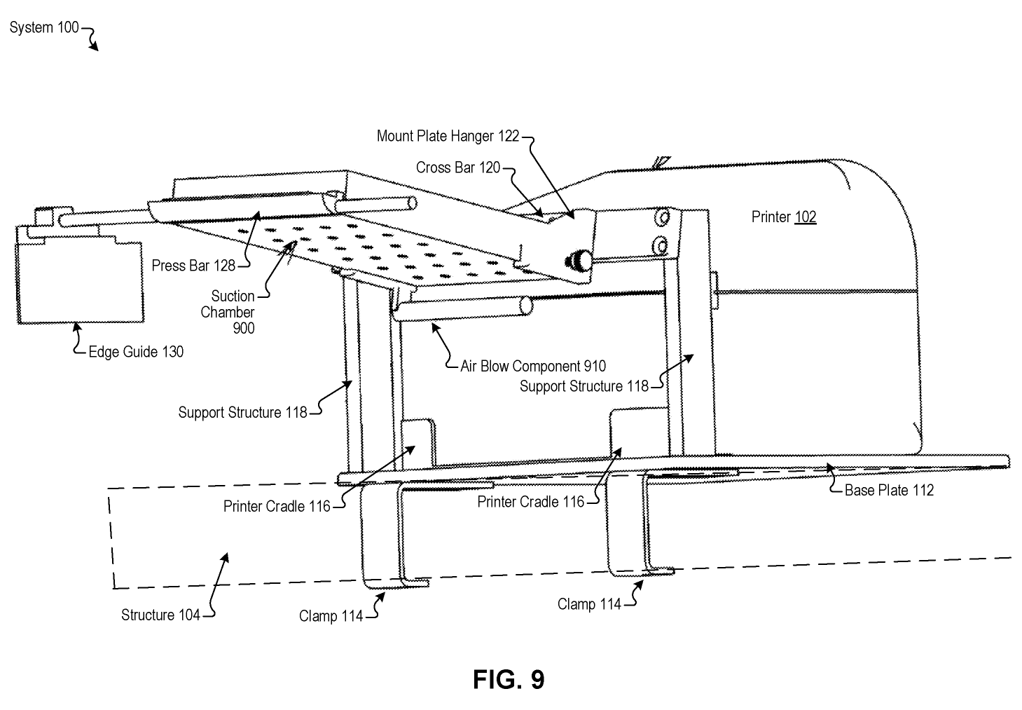

FIG. 9 illustrates a perspective view of a label application device 110, according to certain embodiments. The label application device 110 may be similar to the label application device 110 of one or more of FIGS. 1A-D.

The label application device 110 may include a suction chamber 900 configured to retain an adhesive label 106 via vacuum suction and an air blow component 910 (e.g., air blow tube) configured to direct the adhesive label 106 toward the suction chamber 900 (e.g., as it is ejected from the printer 102).

The label application device 110 may include a press bar 128. A product 600 that is to be labeled is to be pressed against a leading adhesive face of the adhesive label 106 to cause the adhesive label 106 to be pressed against the press bar 128 to cause the adhesive label 106 to be adhered to the product 600. In some embodiments, the suction chamber 900 forms a plurality of holes through which suctioning is provided to releasably secure the adhesive label 106 to the suction chamber 900.

The label application device 110 may have a base plate 112 configured to be placed on a structure 104. The label application device 110 may have one or more clamps 114 connected to the base plate 112 and configured to secure the label application device 110 to the structure 104. The label application device 110 may have a printer cradle 116 configured to at least partially secure a printer 102. The label application device 110 may have one or more support structure 118 (e.g., frame upright structures) that each have a corresponding first distal end secured to the base plate 112. The label application device 110 may have a cross bar 120 connected to the one or more support structures 118. The label application device 110 may have one or more mount plate hangers 122 connected to the cross bar 120, where the suction chamber 900 is coupled to the one or more mount plate hangers 122. The label application device 110 may have an edge guide 130 secured to the press bar 128 to align a product 600 with an adhesive label 106.

In some embodiments, a system 100 includes an air suction chamber 900. The slide channel system may be replaced with a perforated suction chamber 900. The system 100 may include vacuum suction through holes in the chamber 900 that holds the adhesive label 106 in place by its non-adhesive side 152. The system 100 may include a compressed air or fan-based system that generates the vacuum (not shown in drawings). The system 100 may include a blow tube (e.g., air blow component 910) near the peel bar of the printer 102 that helps lift the adhesive label 106 into position under the suction chamber 900. The system 100 may perform label application (e.g., the same as or similar to other embodiments of the present disclosure).

FIGS. 2C-D illustrate a slide channel plate before bending, a textured surface 140 (e.g., tapered and textured edge), and a knurling wheel 200. FIG. 3A illustrates a slide channel plate (e.g., of FIGS. 2C-D) after bending. FIGS. 4A-D illustrate a slide channel plate (e.g., of FIG. 3A) supporting an adhesive label 106.

Reducing the area of contact between the adhesive side 150 of the adhesive label 106 and the channel edge 400 aids in reducing the adhesive bond between the two parts. By beveling the channel edge 400 (e.g., contact edge of the channel) so that the channel edge 400 tapers to a thin edge where the channel contacts the adhesive label 106, the surface area of contact is reduced. Texturing the channel edge 400 (e.g., tapered edge) with a knurling wheel 200 or a coarse abrasive material creates a discontinuous surface at the point of contact with the adhesive side 150 of the adhesive label 106. This discontinuous surface feature further reduces the ability of the adhesive to bond to the channel edge 400 (e.g., metal edge). The process of tapering the channel edge 400 and adding texture to the channel edge 400 may be more difficult to perform on a piece of metal that has already been formed into a channel shape. This is because the small and nearly closed profile of the channel shape makes access for machining tools more difficult. To overcome this restraint, the metal piece may be machined prior to bending the metal into a channel shape. FIGS. 2C-D illustrate a technique for texturing the flat metal channel piece before it is bent. FIGS. 3A and FIGS. 4A-D illustrate the finished slide channel 126 after the flat, tapered and textured piece is bent.

The texturing may provide a discontinuous surface for the adhesive side 150 of the adhesive label 106 to contact. In some embodiments, channel edges 400 of the slide channels 126 are textured with a knurling wheel 200. In some embodiments, the channel edges 400 of the slide channels 126 are textured via one or more machining techniques (e.g., other than or in addition to a knurling wheel 200) for attaining a textured surface 140. In some embodiments, the channel edge 400 is textured (e.g., texturing of the metal edge) by machining the channel edge 400 with a coarse adhesive such as a grinding wheel or sandpaper.

FIG. 3B illustrates a slide channel plate of a label application device 110, according to certain embodiments.

In some embodiments, the texturing includes bonding (e.g., applying adhesive, applying glue to bond) a granular material to the channel edge 400. The granular material creates a discontinuous contact surface for the adhesive in a similar manner as achieved with mechanical texturing. In some embodiments, the channel edge 400 of the slide channel 126 which contacts the label adhesive would first be coated in an epoxy or other glue. Before the glue cures, a coarse granular material such as one or more of silicone carbide, garnet, and/or crushed glass would be applied over the glue area so it bonds to the glue. This would result in a surface similar to sandpaper on the channel edge 400. The choice of granular material and particle size of granular material can be tested with different label adhesive materials. In this way granular materials can be selected which perform best with particular label adhesives.

Because the application of granular material may not require any machine tooling, the application process can be performed on the slide channels 126 before or after they are bent (e.g., with less difficulty). Also, it is possible to apply granular material on the vertical inside web of the channels (e.g., side wall 412). This area of the slide channels 126 can come in contact with the edges of the adhesive labels 106 (e.g., when the slide channels 126 are not positioned accurately in relation to the adhesive labels 106). By applying granular material to this area, issues with labels sticking to the inside web of the slide channels 126 can be overcome. FIG. 3B shows a channel with granular material applied to the channel edge 400 (e.g., contact edge) and the vertical inside web (e.g., inside surface of side wall 412) of the slide channel 126.

FIGS. 5A-D illustrate a slide channel plate of a label application device 110, according to certain embodiments.

In some embodiments, texturing may include applying a textured surface 140 to the channel edges 400 by gluing or bonding a small diameter rod to the channel edge 400. This rod would receive a textured surface 140 treatment before being attached to the channel edge 400. A small metal bar (rectangular or other shape) could be used as an alternative to a rod. FIGS. 5A-D illustrate a slide channel 126 with a bonded rod.

In some embodiments, there may be one or more uses for adhesive resistant textured surfaces 140.

In some embodiments, the textured surface 140 feature is used in applications that are not related to slide channels 126. There are many situations both during the manufacture of adhesive labels 106 and when the adhesive labels 106 are machine applied where incidental contact between the label adhesive coating and machine parts occurs. Machines that apply adhesive tapes can also contain parts that come in contact with the glue on the adhesive tapes. When the machine parts that are in contact with the adhesive are metal, a textured surface 140 can prevent labels from sticking to the parts. The texture can be created by either machining a textured surface 140 on the metal or by bonding a granular material to the metal surface. The procedures for machining the metal and bonding granular material are similar to what was previously described for the slide channels 126.

This application describes some methods for creating a textured surface 140 that can resist forming an adhesive bond with pressure sensitive adhesives. It is understood that other techniques for texturing metal surfaces exist and the techniques described herein are not intended to rule out other means of creating an effective surface texture that can resist adhesive sticking. In some embodiments, one or more textured surfaces 140 may be created using one or more of the processes described herein (e.g., a combination of the processes described herein).

In some embodiments, the system 100 includes a slide channel 126 system, where a label application device 110 includes one or more of:

Label holding assembly with slide channels 126;

Support frame (e.g., one or more support structures 118) and angled crossbar (e.g., cross bar 120);

Base plate 112 with printer cradle 116;

Press bar 128; and/or

Adjustable edge guide 130.

In some embodiments, the system 100 includes slide channels 126.

The slide channels 126 may be constructed from thin stainless steel, each slide channel 126 has an upturned bottom edge (e.g., channel edge 400) that supports the adhesive side 150 of the adhesive label 106. An improved surface (e.g., textured surface) with less friction is obtained by grinding a bevel on the contact edge (e.g., channel edge 400) to create a thinner contact surface. The contact surface is textured to create a discontinuous contact surface for the adhesive side 150 of adhesive label 106. This reduces adhesive drag and the chance of sticking. This texture may be formed via one or more of:

Embossing with a sawtooth or other textured pattern;

Distorting the metal surface with abrasives; and/or

Adhesive-bonded granular material (e.g., crushed glass, silicon carbide, garnet).

The slide channels 126 may be coupled (e.g., affixed, fastened, connected, etc.) to a channel mounting plate 124 (e.g., transparent acrylic channel mounting plate) (e.g., using high-strength tape, such as 3M VHB). The channel mounting plate 124 may be suspended at about negative 10 to about 30 degree upward angle (e.g., at about a ~10° upward angle) using mount plate hangers 122 connected to a cross bar 120. This angled orientation may improve (e.g., optimize) release of the adhesive label 106 from the peel bar of the printer 102. The peel bar may separate the adhesive label 106 from the liner 108.

In some embodiments, the system 100 includes a support frame (e.g., one or more support structures 118) and base plate 112.

The support frame (e.g., one or more support structures 118) may support the label assembly (e.g., slide channels 126, etc.) and may mount onto a base plate 112, which includes a printer cradle 116 for printer alignment (e.g., precise printer alignment). The entire label application device 110 may be secured to a structure 104 (e.g., table or bench) using adjustable clamps 114.

In some embodiments, the system includes a press bar 128 and edge guide 130.

Located at the end of the slide channels 126, the press bar 128 offers a smooth, rounded surface to help transfer the adhesive label 106 onto the product 600 (e.g., packaging). A foam-covered roller can be substituted. An adjustable edge guide 130 assists in aligning the product 600 (e.g., package) for consistent placement of adhesive labels 106.

In some embodiments, during operation, a user weighs an item on a printing weigh scale and then sends a print request to the scale to have the data from the weighing printed on an adhesive label 106. As the adhesive label 106 is ejected from the scale printer 102, the leading edge of the adhesive label 106 passes over the peel bar of the printer 102, separating the adhesive label 106 from the liner 108 (or simulating this function in liner-less systems).

After exiting the printer 102 (e.g., printer body), the adhesive label 106 may immediately enter the label application device 110 (e.g., label holding assembly). The label application device 110 aligns and supports the adhesive label 106 using two substantially parallel slide channels 126. These slide channels 126 may be slightly shorter than the adhesive label 106, allowing the leading edge of the adhesive label 106 to extend slightly beyond the end of the slide channels 126. Responsive to the printer 102 finishing printing, the adhesive label is at least partially contained within the label application device 110 (except for a small portion that remains attached to the label liner paper at the printer peel bar). A press bar 128 is positioned directly above (or to the left for scales that dispense adhesive labels 106 in a vertical orientation) the leading edge of the adhesive label 106.

To apply the adhesive label 106, the user holds the product 600 (e.g., package) on which the adhesive label 106 is to be applied and brings the product upward to contact the exposed leading edge of the adhesive label 106 (for scale printers that eject labels in a vertical orientation, the product 600 is moved horizontally to contact the adhesive label 106). As pressure is applied and the adhesive label 106 is pushed against the press bar 128, this causes the adhesive label 106 to adhere to the product 600. Continued upward (or leftward) and rearward movement of the product causes the remainder of the label to adhere evenly. Once the adhesive label 106 is fully transferred, the process is complete and ready for repetition.

In some embodiments, the present disclosure provides a slide channel system.

The label application device 110 may include one or more of:

Label holding assembly with slide channels 126;

Support Frame (e.g., support structures 118);

Base plate 112 with scale positioning features (e.g., printer cradle 116);

Press bar (e.g., 128); and/or

Adjustable edge guide 130.

The label application device 110 (e.g., label holding assembly) may include a pair of slide channels 126, a channel mounting plate 124, press bar 128, edge guide 130, and/or support structures 118 (e.g., a support frame).

Slide channels 126 are constructed from thin stainless steel or other material, each slide channel 126 has an upturned bottom edge that supports the adhesive side 150 of the adhesive label 106. The upturned bottom edge (e.g., channel edge 400) is specially treated to achieve a surface which has minimal attraction to label adhesive. The low adhesive attraction surface is obtained by first grinding or otherwise forming a bevel on the contact edge (e.g., channel edge 400) to create a thin contact surface. The contact surface is then textured to create a discontinuous contact surface (e.g., textured surface 140) for the label adhesive. The combination of a thin edge with texturing creates a surface that allows an adhesive label 106 to slide along the channel edge 400 without sticking to the channel edge 400. Some methods to texture the channel edges 400 are one or more of:

Embossing with a sawtooth or other textured pattern;

Distorting the metal surface with abrasives;

Adhesive-bonded granular material (e.g., crushed glass, silicon carbide, garnet); and/or

Cutting the metal edge with laser, water jet or machine tools to produce a fine serrated pattern.

The length of the slide channels 126 is based on the length of the adhesive label 106 being applied. The slide channels are formed at (e.g., cut to) a length that is slightly shorter than the length of the adhesive label 106.

The slide channels are affixed to a transparent acrylic channel mounting plate using high-strength adhesive tape (e.g., 3M VHB) or other mechanical fastener. The channels are positioned so the label edges can rest on the upturned channel edge and not contact the vertical web of the channel. The channel mounting plate is attached to a support frame. The attachment of the mounting plate to the support frame allows for mounting plates to be easily switched for different label sizes. The transparent material used for the channel mounting plate allows the user to visually confirm that the label has been dispensed and is ready for application.

Located at the end of the channel mounting plate 124, the press bar 128 offers a substantially smooth, rounded surface to help transfer and press the adhesive label 106 onto the product 600 (e.g., packaging). Alternatively, a roller covered in a foam or rubber material can be used. In some embodiments, an adjustable edge guide 130 mounted in conjunction with the press bar 128 assists in aligning the product 600 (e.g., package) for substantially consistent placement of the adhesive labels 106.

In some embodiments, the present disclosure includes a support frame and base plate.

The support frame (e.g., support structures 118) is mounted on the base plate 112. The scale unit (e.g., printer 102) also sits on the base plate 112. The scale unit is to be accurately positioned on the base plate 112 for the label application device 110 to function properly. To achieve accurate positioning of the scale unit, positioning features are incorporated with the base plate 112. These features can include vertical legs or other restraints which prevent the scale unit from moving in a horizontal direction. In some embodiments, positioning can be provided by providing recessed areas on the base plate 112 for the scale feet to fit in. In some embodiments, the entire scale unit can be secured to structure 104 (e.g., a table or bench) using fasteners or adjustable clamps 114 that are attached to the base plate 112.

In some embodiments, a method includes: texturing a tapered edge of a slide channel plate in a planar shape, the slide channel plate being of a label application device 110; and subsequent to the texturing, bending the slide channel plate into a channel shape, wherein the slide channel plate in the channel shape is to support adhesive labels 106.

In some embodiments, a label application device 110 is for use with a desktop label printer 102. The label application device 110 may include one or more of:

A label holding assembly consisting of a mounting plate and two slide channels, the slide channels, each having a low-friction, textured edge to support the adhesive side of a label during and after it is ejected from the printer; channels mounted on the label holding assembly parallel to each other with an orientation that supports a label that is ejected from the label printer with the adhesive side of the label facing downward,

A mounting plate configured to support said channels that may be mounted at an inclined angle relative to horizontal;

A press bar or roller located above the leading edge of the ejected label to assist in label application; and

A support frame and base plate configured to position a desktop printer for direct label transfer.

Ins some embodiments, the channel edge in contact with the label adhesive is beveled and a texture is applied comprising one or more of: embossed or cut (e.g., machine cut) sawtooth pattern, abrasive surface treatment, or bonded granular coating.

In some embodiments, a lubricant (e.g., silicone oil or other similar lubricant) is applied to the textured edge.

In some embodiments, the label holding assembly is inclined at an angle of between negative 10 and 30 degrees from horizontal to facilitate label separation from the printer's peel bar.

In some embodiments, the label application device 110 includes an adjustable edge guide to assist in label alignment and placement during application. The sliding rod supporting the edge guide has printed ruler markings to assist in accurate placement of the edge guide.

In some embodiments, the label application device 110 includes one or more of:

a suction chamber with a pattern of holes configured to retain a label via vacuum suction;

an air blow mechanism to assist in directing the label toward the suction chamber; and/or

a press bar for completing label application to packaging.

In some embodiments, label application device 110 is for use with portable printing weigh scales, the label application device 110 may include one or more of:

A label holding assembly with parallel slide channels, each slide channel having a beveled and textured edge to support the adhesive side of a label;

A transparent mounting plate configured to support said channels;

A press bar positioned at the end of the mounting plate to assist in label application;

A support frame configured to accurately position the mounting plate so labels are ejected directly into the slide channels and;

A base plate configured to accurately position and restrain movement of the printing weigh scale for direct label transfer.

In some embodiments, the channel edge in contact with the label adhesive is beveled and a texture is applied to create a discontinuous contact surface with the label adhesive.

In some embodiments, the label holding assembly is inclined at approximately 10 degrees from the plane of the ejected label to facilitate label separation from the label liner paper at the peel bar.

In some embodiments, the label application device 110 includes an adjustable edge guide to assist in label alignment and placement during application.

In some embodiments, a label application device 110 is for use with portable printing weigh scales. The label application device 110 may include one or more of:

a label holding fixture which supports a peeled label as it is ejected from a portable printing weigh scale;

The device of claim 1 wherein the peeled label is kept in a substantially linear shape as it is being ejected.

In some embodiments, the peeled label is supported in a manner that allows it to eject from the printer weigh scale with minimal frictional drag and also allows the label to be removed from the fixture with minimal frictional drag.

In some embodiments, labels are ejected from the printing weigh scale in either a horizontal for vertical plane.

In some embodiments, the label that are ejected in a horizontal plane are orientated with the adhesive face of the label facing downward.

In some embodiments, the fully ejected peeled label is held so that the adhesive face of the leading edge of the label is fully exposed for application to an article.

In some embodiments, the label holding fixture is inclined at approximately 10 degrees from the plane of the ejected label to facilitate label separation from the printer's peel bar.

In some embodiments, the label application device 110 includes an adjustable edge guide to assist in label alignment and placement during application.

In some embodiments, the label application device 110 includes a cylindrical shaped press bar or alternatively a roller, which is positioned in alignment with the leading edge of the ejected label and positioned opposite to the adhesive coated face of the label. The position of the press bar being such that an article that is to be labeled can be pressed against the leading adhesive face of the label and the label is in turn pressed against the press bar so that the label becomes adhered to the article.

In some embodiments, the label application device 110 is a semi-automatic device that applies adhesive labels 106 that are printed by a portable stand-alone label printer 102.

The label application device may be an accessory that works in conjunction with particular types of label printers 102. The label printer types would follow these criteria:

The label printer can be a type that prints labels using any printing technology (thermal, ink jet laser, etc.). The label printer may eject a printed label with the liner paper peeled from the label. The printer 102 may also be of a type that prints on liner-less labels. The label printer can be a desktop type (e.g., barcode printer or a desktop thermal printer). The label printer can also be an industrial type. These are larger printers and often use either thermal or ink jet technology to print a label.

The label application device 110 may not use any modification of the label printer to operate. Since substantially all label printers eject labels with the adhesive side of the label facing down, there exists a need to develop a label applicator that could apply labels that are orientated with the adhesive side of the label facing downward. The label application device 110 fulfills this need.

The label application device 110 uses channel slide technology to hold onto a label as the label is ejected from a printer. This technology allows the label application device 110 to function without any electric or other external power.

The label application device 110 is to have the label printer positioned precisely with respect to the label application device 110 so labels that are ejected from the label printer enter into the slide channels without interference.

Two features of the applicator are used to position a label printer properly.

The first feature is the support structures 118 (e.g., frame uprights). The height of the frame uprights is custom sized for individual printer models. This height adjustment dictates the vertical height of the channels above the base plate. If the channels are too high or too low, the labels may not enter into the channel space when ejected from the printer.

The second feature that is used for positioning a printer is the printer cradle that is mounted on the base plate. The printer cradle is custom fitted to the printer base and when the printer is set in the cradle, the printer is restrained from moving in a horizontal plane. The cradle is attached to the base plate at a position that results in proper alignment of the printer with the applicator slide channels. The cradle allows the label printer to be easily removed from the applicator for conventional use without the label application device 110 and then easily reinstalled when use of the label application device 110 is desired.

In some embodiments, the present disclosure provides an improved method to fabricate a slide channel 126 (e.g., channel slide device).

In some embodiments, texturing of the channel edges 400 is via embossing the channel edge 400 with a knurling wheel 200.

The channel edge 400 may be embossed before the channel shape is formed (e.g., while the metal is still flat). This gives better access to the metal edge so the inside edge of the channel edge 400 can be embossed with the knurling wheel 200.

The channel edge 400 may also be textured via gluing abrasive on the edge, beveling the edge, and/or using a coarse sandpaper or grinding wheel to texture the edge.

Label adhesives do not adhere well to textured surfaces. This is part of the reason that the slide channels 126 function well in the label application device 110. This feature can also be applied to machinery that manufacturers and/or handles adhesive labels. In some embodiments, texturing can be used to treat rollers and other parts that may contact label adhesive during manufacturing processes.

In some embodiments, the terms "first," "second," "third," "fourth," etc. as used herein are meant as labels to distinguish among different elements and do not have an ordinal meaning according to their numerical designation.

The above description is intended to be illustrative, and not restrictive. Although the present disclosure has been described with references to specific illustrative examples and implementations, it will be recognized that the present disclosure is not limited to the examples and implementations described. Many other embodiments will be apparent to those of skill in the art upon reading and understanding the above description. The scope of the disclosure should be determined with reference to the following claims, along with the full scope of equivalents to which the claims are entitled.

The preceding description sets forth numerous specific details such as examples of specific systems, components, methods, and so forth in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms "first," "second," "third," "fourth," etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ± 10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A label application device comprising:a channel mounting plate; anda first slide channel and a second slide channel connected to the channel mounting plate substantially parallel to each other, wherein the channel mounting plate is configured to secure the first slide channel and the second slide channel at an angle of about negative 10 degrees to about 30 degrees relative to a horizontal plane to receive an adhesive label directly from a printer and to facilitate separation of backing paper from the adhesive label via a peel bar, and wherein the first slide channel and the second slide channel each have a corresponding textured surface to provide a discontinuous contact surface for receiving the adhesive label with adhesive side down during and after the adhesive label is ejected from the printer.

2. The label application device of claim 1, wherein at least one of:the channel mounting plate is substantially transparent; or the adhesive label is liner-less.

3. The label application device of claim 1, wherein each corresponding textured surface is textured with one or more of an embossed or cut sawtooth pattern, abrasive surface treatment, or bonded granular coating.

4. The label application device of claim 1, wherein a lubricant comprising silicone oil or similar lubricant is applied to each corresponding textured surface.

5. The label application device of claim 1, wherein the printer is one or more of:a desktop or industrial type printer that is configured to print the adhesive label via one or more of thermal printing or ink jet laser printing; or a portable printing weigh scale.

6. The label application device of claim 1, wherein:
the first slide channel and the second slide channel maintain the adhesive label in a substantially planar position responsive to the adhesive label being ejected from the printer; and
the adhesive label is secured by the first slide channel and the second slide channel to cause an adhesive face of a leading edge of the adhesive label to be fully exposed for application to a product.

7. The label application device of claim 1 further comprising:a base plate configured to be placed on a structure;one or more clamps connected to the base plate, wherein the one or more clamps are configured to releasably connect the label application device to the structure; anda printer cradle connected to the base plate, wherein the printer cradle is configured to at least partially restrain movement of the printer, and wherein the printer cradle is configured to position the printer to eject the adhesive label into the first slide channel and the second slide channel.

8. The label application device of claim 7 further comprising one or more frame upright structures that each have a corresponding first distal end connected to the base plate, wherein the one or more frame upright structures position the first slide channel and the second slide channel at a height to directly receive the adhesive label ejected from the printer to cause a first side of the adhesive label to be disposed in the first slide channel and a second side of the adhesive label to be in the second slide channel with an adhesive side of the adhesive label facing down and liner paper peeled from the adhesive label.

9. The label application device of claim 8 further comprising:a cross bar connected to a corresponding second distal end of each of the one or more frame upright structures; andone or more mount plate hangers connected to the cross bar, wherein the channel mounting plate is coupled to the one or more mount plate hangers.

10. The label application device of claim 1 further comprising a press bar coupled to the channel mounting plate, wherein the press bar is a cylindrically-shaped
structure positioned in alignment with a leading edge of the adhesive label and positioned opposite to the adhesive side of the adhesive label, and wherein a product that is to be labeled is to be pressed against a leading adhesive face of the adhesive label to cause the adhesive label to be pressed against the press bar to cause the adhesive label to be adhered to the product.

11. The label application device of claim 10 further comprising an adjustable edge guide coupled to the press bar, wherein the adjustable edge guide is configured to align the product with the adhesive label.

12. A method comprising:causing a first adhesive label receiving surface of a first metal structure and a second adhesive label receiving surface of a second metal structure to be textured to generate a first partially textured metal structure and a second partially textured metal structure; and causing the first partially textured metal structure and the second partially textured metal structure to be used as a first slide channel and a second slide channel of a label application device, wherein a printer is to eject an adhesive label with an adhesive side down onto corresponding textured surfaces of the first slide channel and the second slide channel.

13. The method of claim 12, wherein the causing of the first partially textured metal structure and the second partially textured metal structure to be used as the first slide channel and the second slide channel comprises causing the first partially textured metal structure and the second partially textured metal structure to be bent to generate the first slide channel and the second slide channel.

14. The method of claim 12, wherein the causing of the first adhesive label receiving surface and the second adhesive label receiving surface to be textured is via one or more of:embossing with a knurling wheel;cutting with machining tools;using a grinding wheel;
using a coarse sandpaper;
beveling;
gluing abrasive; or applying a coating.

15. The method of claim 12 further comprising connecting the first slide channel and the second slide channel substantially parallel to each other to a channel mounting plate of the label application device.

16. The method of claim 15, wherein the channel mounting plate is configured to secure the first slide channel and the second slide channel at an angle of about negative 10 degrees to about 30 degrees relative to a horizontal plane to receive the adhesive label directly from the printer and to facilitate separation of backing paper from the adhesive label via a peel bar.

17. The method of claim 15, wherein the corresponding textured surfaces are configured to provide a discontinuous contact surface for receiving the adhesive label with the adhesive side down during and after the adhesive label is ejected from the printer.

18. A label application device comprising:a suction chamber configured to retain an adhesive label via vacuum suction;an air blow component configured to direct the adhesive label toward the suction chamber; anda press bar, wherein a product that is to be labeled is to be pressed against a leading adhesive face of the adhesive label to cause the adhesive label to be pressed against the press bar to cause the adhesive label to be adhered to the product.

19. The label application device of claim 18, wherein the suction chamber forms a plurality of holes through which suctioning is provided to releasably secure the adhesive label to the suction chamber.

20. The label application device of claim 19 further comprising:
a base plate configured to be placed on a structure;
one or more clamps connected to the base plate and configured to secure the label application device to the structure;
a printer cradle configured to at least partially secure a printer;
one or more frame upright structures that each have a corresponding first distal end secured to the base plate;
a cross bar connected to the one or more frame upright structures;
one or more mount plate hangers connected to the cross bar, wherein the suction chamber is coupled to the one or more mount plate hangers; and
an edge guide secured to the press bar to align the product with the adhesive label.
